(19) United States
(12) Patent Application Publication
(10) Pub. No.: US 2002/0116316 A1
(43) Pub. Date: Aug. 22, 2002

(54) Auction manager system and method of operation

(76) Inventor: Peter Griffiths, Beverly Hills, CA (US)

Correspondence Address: Christopher J. Rourk, AKIN, GUMP, STRAUSS, HAUER & FELD, L.L.P., P.O. Box 688, Dallas, TX, 75313-0688, US

(21) Appl. No.: 09/790,311

(22) Filed: Feb. 21, 2001

(51) Int. Cl. G06F 17/60

(52) U.S. Cl. 705/37; 705/26

(57) ABSTRACT

An auction manager system is provided. The auction manager system includes a master listing system that receives lot listing data and provides the lot listing data to at least one of two or more auction systems. A master bidding system is connected to the master listing system and receives the bid data associated with the lot listing data. The master bidding system then provides the bid data to at least one of two or more auction systems.

### FIELD OF THE INVENTION

The present invention pertains to the field of online sales systems. More specifically, the invention relates to a system and method for managing online auctions that allows auctions on a plurality of auction systems to be coordinated through a central auction manager so as to allow auction listings to be consolidated.

### BACKGROUND

Online auction systems are known in the art. These online auction systems allow users to access an auction system, such as a web site over the Internet, to view listings for lots that have been placed for bid, to place lots for sale, to place bids on those lots, and then to coordinate the closing of the sale after the completion of the auction. These online auction systems have allowed buyers and sellers in geographically diverse areas to participate in such auctions, and have resulted in significant economic activity.

Although such auction systems have been widely implemented, they are in part a victim of their own success. There are presently a large number of such online auction systems in operation, such that a party interested in bidding on certain types of items may have to access dozens of auction systems on a regular basis in order to find all listed items of interest. Likewise, a person seeking to sell an item on an auction system must make a decision about which auction system to sell on based on the number of expected potential bidders, the number of similar items listed on such site that have sold (indicating an interest the attention of interested parties), or other factors. Thus, while online auction systems provide significant utility, the ease of setting up an online auction system and the resulting large number of such online auction systems greatly complicates the processes of 1) selecting a system on which to list a lot and 2) finding lots of interest on which to bid.

### SUMMARY OF THE INVENTION

In accordance with the present invention, an auction manager system and method of operation are provided that overcome known problems with selling assets online.

In particular, an auction manager system and method of operation are provided that allow auction listings for two or more sites to be consolidated, so as to allow the listings on different sites to be made available to bidders at all sites.

In accordance with an exemplary embodiment of the present invention, an auction manager system is provided. The auction manager system includes a master listing system that receives lot listing data and provides the lot listing data to at least one of two or more auction systems. A master bidding system is connected to the master listing system and receives the bid data associated with the lot listing data. The master bidding system then provides the bid data to at least one of two or more auction systems.

The present invention provides many important technical advantages. One important technical advantage of the present invention is an auction manager system that coordinates two or more auction systems so that the lot listings of each system can be shared. In this manner, the number of potential bidders can be increased, thus increasing the potential sales price that might be obtained for a lot, while preventing the lot from inadvertently being awarded to two different bidders.

Those skilled in the art will further appreciate the advantages and superior features of the invention together with other important aspects thereof on reading the detailed description that follows in conjunction with the drawings.

### BRIEF DESCRIPTION OF THE DRAWINGS

FIG. 1 is a diagram of a system for managing online auctions in accordance with an exemplary embodiment of the present invention;

FIG. 2 is a diagram of a system for coordinating listings between auction systems in accordance with an exemplary embodiment of the present invention;

FIG. 3 is a diagram of a system for coordinating bidding on a plurality of auction systems in accordance with an exemplary embodiment of the present invention;

FIG. 4 is a diagram of a system for interfacing an auction system with an auction manager system in accordance with an exemplary embodiment of the present invention;

FIG. 5 is a flow chart of a method for coordinating lot listings and bids through an auction manager in accordance with an exemplary embodiment of the present invention; and

FIG. 6 is a flowchart of a method for allowing multiple auction systems to carry a lot listing and for allowing users to bid on the lot listing through two or more auctions systems in accordance with an exemplary embodiment of the present invention.

### DETAILED DESCRIPTION OF PREFERRED EMBODIMENTS

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

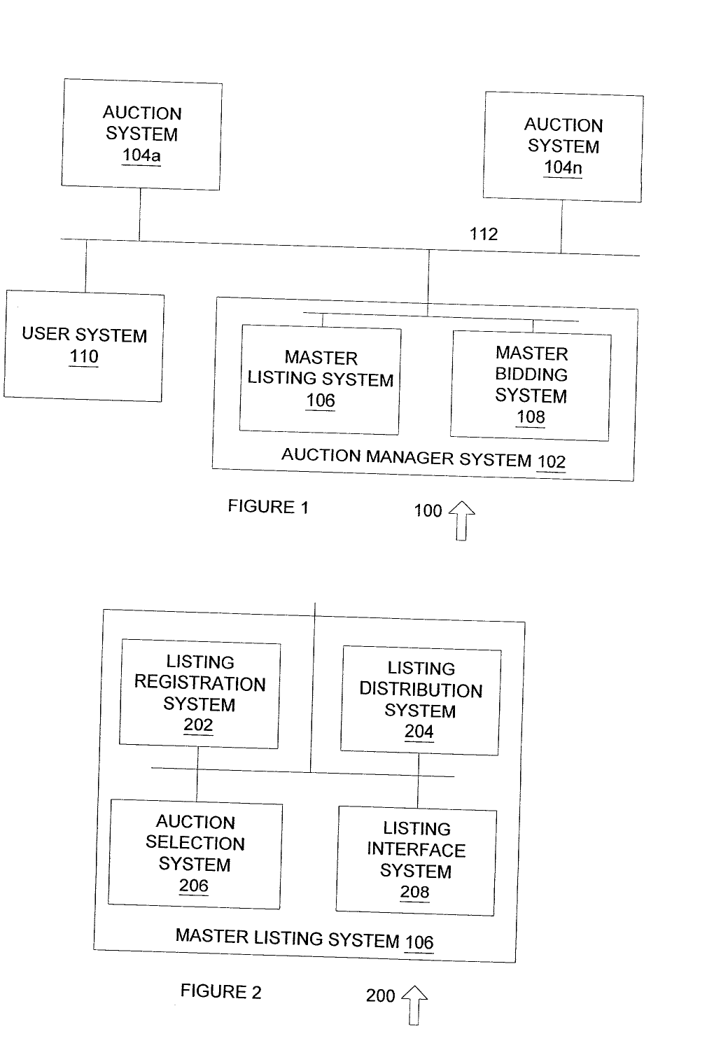

FIG. 1 is a diagram of a system 100 for managing online auctions in accordance with an exemplary embodiment of the present invention. System 100 allows a plurality of auction systems to be coordinated through an auction manager system so that a lot can be placed for sale on two or more different systems without creating a situation in which it is possible for the lot to be sold more than once.

System 100 includes auction manager system 102, which can be implemented in hardware, software, or a suitable combination of hardware and software, and which can be one or more software systems operating on a general purpose server platform. As used herein, a software system can include one or more objects, agents, threads, lines of code, subroutines, separate software applications, two or more lines of code or other suitable software structures operating in two or more software applications or on two or more processors, or other suitable software structures. In one exemplary embodiment, a software system can include one or more lines of code or other suitable software structures operating in a general purpose software application, such as an operating system, and one or more lines of code or other suitable software structures operating in a specific purpose software application. In another exemplary embodiment, a software system can include a web browser receiving hypertext markup language (*HTML) data that is used by the web browser system to generate a display that prompts the user to enter predetermined information.

Auction manager system 102 is coupled to auction systems 104a through 104n over communications medium 112. As used herein, the term “coupled”, and its cognate terms such as “couples” and “coupled”, can include a physical connection (such as through a copper conductor), a virtual connection (such as through one or more randomly assigned memory locations in a data memory device), a logical connection (such as through one or more logical devices of a semiconducting circuit), a wireless connection, other suitable connections, or a suitable combination of such connections. In one exemplary embodiment, systems and components are coupled to other systems and components through intervening systems and components, such as through an operating system of a general purpose server platform.

Auction systems 104a through 104n are separate auction systems, such as auction web sites, auction servers, or other suitable auction systems, and can each be one or more software systems operating on general purpose server platforms. Communications medium 112 can be a local area network (LAN), a wide area network (WAN), the Internet, a wireless network, the public switched telephone network (PSTN), an optical network, a combination of such communication media, or other suitable communication media.

Each auction system 104a through 104n is configured to independently perform online auction services for one or more user systems 110. In one exemplary embodiment, an operator of user system 110 can place a lot for sale, view listed lots, place bids on listed lots, and coordinate the sale and transfer of the lot from the seller to the successful bidder using any of auction systems 104a through 104n.

User system 110 can be implemented in hardware, software, or a suitable combination of hardware and software, and can be one or more software systems operating on a general purpose processing platform. In one exemplary embodiment, user system 110 is a web browser system that receives *.HTML or other suitable data from auction systems 104a through 104n, and allows the user to list lots, view lots, bid on lots, and perform other suitable functions with auction systems 104a through 104n.

Auction manager system 102 interfaces with auction systems 104a through 104n to allow each of the listings on auction systems 104a through 104n to be coordinated and consolidated. In one exemplary embodiment, auction manager system 102 can be an auction system 104 that has been designated by suitable processes as the primary auction system. Auction manager system 102 includes master listing system 106 and master bidding system 108. Master listing system 106 allows a user system 110 to place listings directly with auction manager system 102, and to select which of the plurality of auction systems 104a through 104n the user system wishes to have the listings also placed on. Likewise, master listing system 106 can allow the user system 110 to place a listing on any of auction systems 104a through 104n, and to select which, if any, of the other auction systems (including master listing system 106) the user wishes the listing to be available through. Master listing system 106 can thus interface with auction systems 104a through 104n and user system 110 to list an auction lot and to obtain lot listing information.

In one exemplary embodiment, master listing system 106 can present a user with listing data fields, such as by providing *.HTML data to a web browser operating on the user system 110 that specifies the data fields required to place a lot listing for viewing on master listing system 106, on one or more of the auction systems 104a through 104n, or on a suitable combination of such systems. Master listing system 106 can also post the data fields on each of auction systems 104a through 104n.

In another exemplary embodiment, master listing system 106 can receive the lot listing data fields from one of the auction systems 104a through 104n in addition to selection data that identifies one or more of the other auction systems 104a through 104n through which the lot listing is to be made available. Master listing system 106 can then post the data fields on each of auction systems 104a through 104n, such as by interfacing with listing systems on each of those other auction systems.

Master bidding system 108 allows a user of user system 110 to either place bids directly on lots listed through master bidding system 108, or can alternatively allow the user to place bids through any of auction systems 104a through 104n, and can coordinate the publication of such bids to the other auction systems on which the lot listing is placed. Master bidding system 108 can thus receive multiple concurrent bids from a plurality of user systems 110 through auction systems 104a through 104n, and can determine the priority of bidding for such bids. In this manner, master bidding system 108 can allow a lot listed on a plurality of auction systems 104a through 104n to be bid on, and can ensure that the bidder having priority is awarded the lot at the completion of the auction.

Auction manager system 102 can also be used to coordinate the post-auction closing on the lot. For example, each of auction systems 104a through 104n may have certain predetermined protocols for handling closing on lots, such as by billing listing providers for fees, by ensuring that bidders either pay for lots and banning nonpaying bidders from bidding, by notifying the next highest bidder in the event that a bidder does not pay for a lot, or by performing other suitable functions. Auction manager system 102 can also perform such functions, or can coordinate the performance of such functions between diverse auction systems 104a through 104n. Each auction system 104a through 104n can also directly interface with other auction systems 104a through 104n to close lots after bidding is completed, or other suitable procedures can be used.

Auction manager system 102 can also coordinate fee sharing between auction systems 104a through 104n. In one exemplary embodiment, an auction system 104a may receive a lot listing, but the winning bidder may purchase the lot through auction system 104n. In this exemplary embodiment, auction manager system 102 can apply predetermined rules to allocate the distribution of auction listing fees assessed to the seller or buyer between auction systems 104a and 104n.

In operating, system 100 allows a plurality of auction systems 104a through 104n to consolidate lots and coordinate bidding so as to ensure that users bidding on such lots through individual auction systems 104a through 104n will be given proper bid priority. System 100 also coordinates and facilitates lot listing and post closing activities, so as to allow sellers to list lots, buyers and sellers to complete the transaction, and to assess fees that may be due to the various buyers, sellers, auction systems 104a through 104n and other parties.

FIG. 2 is a diagram of a system 200 for coordinating listings between auction systems in accordance with an exemplary embodiment of the present invention. System 200 includes master listing system 106 and listing registration system 202, listing distribution system 204, auction selection system 206, and listing interface system 208, each of which can be implemented in hardware, software, or a suitable combination of hardware and software, and which can be one or more software systems operating on a general purpose server platform.

Listing registration system 202 receives auction lot listing data from a user. In one exemplary embodiment, listing registration system 202 can transmit *.HTML or other suitable code to a web browser or other suitable system operating on the user's general purpose processing platform or other suitable interface devices over the Internet or other suitable communications media. Listing registration system 202 receives seller identification information (such as name, address, credit card account for charges or payments, user ID, password, and other suitable information), listing information (such as number of items, starting bid, reserve price, lot description, and other suitable information), and other other suitable information (such as allocation of shipping costs, taxes, and the location of the lot). Listing registration system 202 can also transmit confirmation information to the seller, such as an email that includes all of the information entered by the seller and a request that the seller confirm or modify any incorrect information.

Listing distribution system 204 interfaces with each of the plurality of auction systems 104a through 104n to place lot listings on those auction systems for subsequent viewing by potential bidders. In one exemplary embodiment, listing distribution system 204 can interface with listing registration system 202, auction selection system 206, and listing interface system 208 to receive listings and auction system selections and to distribute the listings to predetermined auction systems. Listing distribution system 204 can also verity that the listing information provided to each auction system 104a through 104n has been correctly posted. For example, listing distribution system 204 can access each auction system 104a through 104n, receive the listing information from the auction system 104a through 104n and compare that information with the information received from listing registration system 202, auction selection system 206, and listing interface system 208 to verify that the information is correct.

Auction selection system 206 receives one or more auction system selections from a seller and uses those selections to list the lot on the auction systems selected by the seller. Auction selection system 206 can allow a seller to set up predetermined lists of auction systems, can allow a seller to exclude certain auction systems, can associate the list of auction systems selected by the seller with the lot, such that the seller can indicate a plurality of lists or a new list for each lot, and can perform other suitable functions. Auction selection system 206 can also interface with listing distribution system 204 and master bidding system 108 or other suitable systems as required to verify that the selected auction systems have the correct lot listing information and that bids received on the lot are updated on each such auction system.

Listing interface system 208 interfaces with each of the plurality of auction systems 104a through 104n and receives lot listing information from such auction systems. In one exemplary embodiment, listing interface system 208 interfaces with one or more systems operating on auction systems 104a through 104n, receives lot data from an initiating auction system, and provides the lot data to listing distribution system 204 so that the lot data can be listed on other auction systems 104a through 104n. In this exemplary embodiment, listing interface system 208 receives one or more data fields from the initiating auction system and maps the data to the corresponding data fields for other auction systems. Listing interface system 208 can also receive auction system selection data from the auction system 104a through 104n on which the lot is initially listed.

In operation, system 200 is used to coordinate the listing of auction lots on a plurality of auction systems 104a through 104n from an initiating auction system, and also allows a user to place a listing directly onto a master listing system 106 for subsequent distribution to one or more auction systems. System 200 thus facilitates the coordination and distribution of lot listings to allow a seller to easily place a lot on a plurality of auction systems.

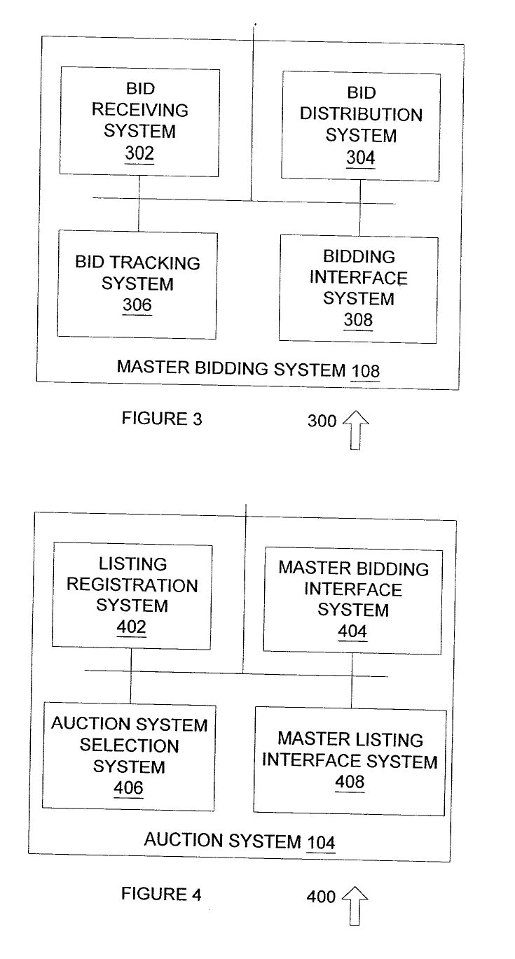

FIG. 3 is a diagram of a system 300 for coordinating bidding on a plurality of auction systems in accordance with an exemplary embodiment of the present invention. System 300 includes master bidding system 108 and bid receiving system 302, bid distribution system 304, bid tracking system 306, and bidding interface system 308, each of which can be implemented in hardware, software, or a suitable combination of hardware and software, and which can be one or more software systems operating on a general purpose server platform.

Bid receiving system 302 receives bid data for auction lots directly from users. Bid receiving system 302 can generate *.HTML or other suitable data that allows the user to view available lots, log in as a bidder, place bids, and otherwise interface with auction manager system 102 so as to bid directly on available lots. Bid receiving system 302 can also interface with bid distribution system 304 and bid tracking system 306 to provide the bid data to other auction systems on which the lot for the bid is listed.

Bid distribution system 304 receives bid data from bid receiving system 302 and bidding interface system 308 and distributes the bid data to the auction systems 104a through 104n on which the corresponding lot is listed. Bid distribution system 304 can interface with an auction selection system 206 for each lot so as to determine which auction systems 104a through 104n should receive the bid data. Bid distribution system 304 can also verify the accuracy of the listed bid data, such as by accessing each auction system, receiving the posted bid data, determining whether the posted bid data matches the actual bid data, and the lag time between the provision of the posting and the updating of the posting.

Bid tracking system 306 is used to coordinate time data for bids received from the plurality of auction systems 104a through 104n and master bidding system 108. For example, the location of auction systems 104a through 104n can be in different time zones, and the local clock on such auction systems 104a through 104n can run at different times. Bid tracking system 306 is used to coordinate such bids, such that a bid coming from an auction system 104a through 104n can be accurately tracked against other bids so that the bidder having priority can be awarded the lot. Bid tracking system 306 can also be used to determine the bidding history, such as by storing identification data for each bidder and amount bid, to confirm that bids are being correctly posted with auction systems 104a through 104n through bid distribution system 304, and can perform other suitable functions.

Bidding interface system 308 receives bid data from each of the auction systems 104a through 104n and provides the bid data to other auction systems 104a through 104n through bid distribution system 304. For example, bidding interface system 308 can interface with a bidding interface system on each auction system 104a through 104n, can receive bidder identification data, lot identification data, bid amount data, time data, and other suitable data from such auction systems for provision to other auction systems. Bidding interface system 308 also interfaces with bid tracking system 306 and bid distribution system 304 and provides suitable data to those systems.

In operation, system 300 is used to coordinate bidding on lots such that bids can be placed on lots listed on multiple auction systems without creating the possibility of having to award the lot to more than one bidder. System 300 thus allows multiple auction systems to share lots and to coordinate bids for such lots, so as to greatly enhance the lot offerings available through any of the auction systems or through the auction manager system.

FIG. 4 is a diagram of a system 400 for interfacing an auction system with an auction manager system 102 in accordance with an exemplary embodiment of the present invention. System 400 includes auction system 104 and listing registration system 402, master bidding interface system 404, auction system selection system 406, and master listing interface system 408, each of which can be implemented in hardware, software, or a suitable combination of hardware and software, and which can be one or more software systems operating on a general purpose server platform. In one exemplary embodiment, the systems of system 400 can generate *.HTML, extensible Markup Language (.XML), Wireless Markup Language (*.WML), or other suitable software that transforms a general purpose web browser software application into a specific purpose software system, so as to gather data from an operator of a user system.

Listing registration system 402 receives lot listing data from a seller and transfers the lot listing data to an auction manager system 102, an auction system 104, or other suitable systems. Listing registration system 402 can also present the seller with the option of having the listing placed on multiple auction systems, and can perform additional registration processes that may be required to facilitate such listing. In one exemplary embodiment, listing registration system 402 can interface with existing users of an auction system 104 and can present them with additional contractual obligations that may need to be entered into in order to allow their listing to be placed on other auction systems.

Master bidding interface system 404 receives bid data for a lot from a buyer and coordinates with an auction system, an auction manager system, or other suitable systems to place the bids on the other auction systems. Master bidding interface system 404 also receives such bids posted through other auction systems, such as from an auction manager or directly from the other auction systems, and updates the auction listing to show the current bid data. Master bidding interface system 404 can also interface with an existing bidding update system operating on auction system 104.

Auction system selection system 406 provides a user listing through listing registration system 402 with the available auction system selections for other auction systems. In one exemplary embodiment, auction system selection system 406 allows the user to select a predetermined list of auction systems, auction system lists for predetermined types of lots, or other suitable functionality.

Master listing interface system 408 receives listing information through listing registration system 402 and provides the listing information to an auction manager, to other auction systems, or to other suitable systems. Likewise, master listing interface system 408 can interface with the auction manager, other auction systems, or other suitable systems to receive listing data from other systems and to post the listing data for viewing by users of the auction system. Master listing interface system 408 can map data fields from those collected through auction system 104 to data fields that may be required or used by an auction manager system, other auction systems, or other suitable systems. In this manner, master listing interface system 408 facilitates the coordination of data transfer between an auction manager, a local auction system, other auction systems, or other suitable systems or combinations of systems.

In operation, system 400 allows an auction system 104 to coordinate with an auction manager and other suitable systems to facilitate the coordination of listings and bids on lots. System 400 can be incorporated into an auction system, can be an add on system that interfaces with an existing auction system, or can have other suitable software architectures to facilitate the interaction between one or more auction systems 104, auction manager system 102, or other suitable systems.

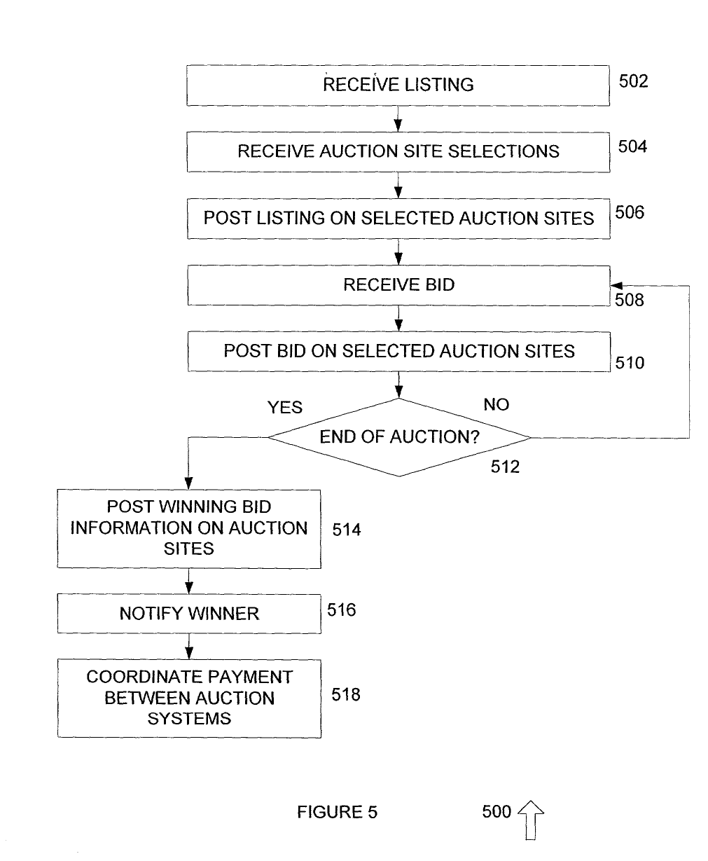

FIG. 5 is a flow chart of a method 500 for coordinating lot listings and bids through an auction manager in accordance with an exemplary embodiment of the present invention. Method 500 begins at 502 where a lot listing is received. The lot listing can include one or more data fields, such as identification data for the seller, identification data for the lot, and other suitable data. The lot listing data can be received directly from a user, from one or more sites, or through other suitable procedures. The method then proceeds to 504.

At 504, auction system selections are received from the user providing the lot listing. These auction system selections can include one or more predetermined sets of auction systems for predetermined lot types, auction restriction sites for sites that should not receive the lot, or other suitable site selections. The auction system selections can be received directly from the user, from a user-entered selection through one or more auction systems, or by other suitable procedures. The method then proceeds to 506.

At 506, the lot listing is posted on the selected auction systems. In one exemplary embodiment, the data fields provided through each site can be determined, mapped, or otherwise coordinated so that the master lot listing data received at 502 can be coordinated with each of the plurality of auction systems. Likewise, the site lot listing can be verified, such as by accessing the site, receiving lot listing information from the site, and performing a comparison of the data that was provided with the lot data that is listed on the site. Other suitable functions can be performed. The method then proceeds to 508.

At 508, bid data is received. The bid data can be received directly from a bidder, through one or more of the selected sites, or in other suitable manners. The method then proceeds to 510.

At 510, the bid is posted on the selected auction systems. The bid data can be filtered so as to provide the bid data in a predetermined format, with predetermined data fields, or in other suitable manners so as to facilitate the posting of bids. Likewise, each site can be accessed to determine whether the data is being accurately received and processed. The method then proceeds to 512.

At 512, it is determined whether the auction has ended. If the auction has not ended, then the method returns to 508 where additional bid data is received. If the auction has ended, the method proceeds to 514 where winning bid data is posted on the auction systems. For example, the winning bid data can include the price of the lot, the winning bidder, or other suitable information. The method then proceeds to 516 where the winner of the winning lot is notified. For example, the winner can be directly notified, can be notified through the auction system which the bidder bid through, or can be otherwise notified. The method then proceeds to 518.

At 518, the payment is coordinated between the auction systems involved with the sale. In one exemplary embodiment, if a lot has been listed through a first auction system and the winning bidder on the lot came through a second auction system, the payment for the lot can be coordinated through an auction manager, can be coordinated through each of the individual auction systems, or can be coordinated in other suitable manners. Likewise, the allocation of lot listing fees, such as a percentage of the price of the lot, a fixed price on the lot, or other suitable fees, can be performed at 518.

In operating, method 500 provides coordination of multiple auction systems through a central auction manager so that listings and bids can be properly processed. Method 500 allows a central site to interface with two or more diverse auction systems and provide such auction services. Method 500 also allows the central site to allow users to directly access the placement of listings and placement of bids.

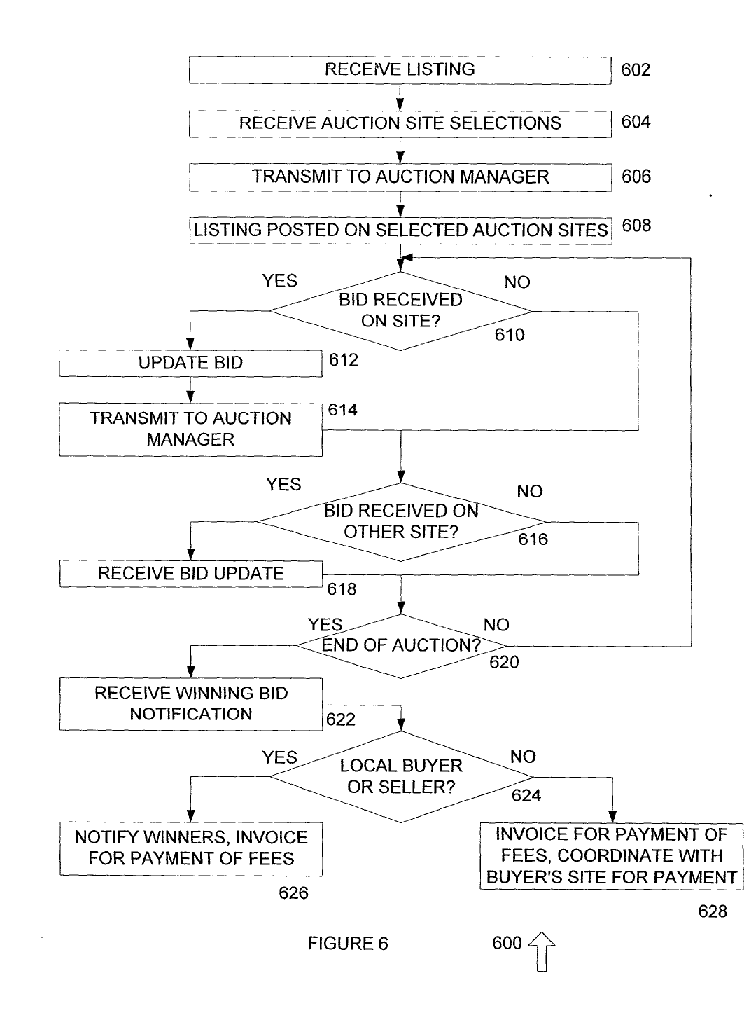

FIG. 6 is a flowchart of a method 600 for allowing multiple auction systems to carry a lot listing and for allowing users to bid on the lot listing through two or more auctions systems in accordance with an exemplary embodiment of the present invention.

Method 600 begins at 602 where the lot listing data is received. The lot listing data can include data that is provided directly from a user of the auction system, data received from an auction manager, or other suitable data. The lot listing data can include the user name, the user ID and password, lot description information, or other suitable information. The method then proceeds to 604.

At 604, auction system selections are received. If the listing is being provided through the auction system, the auction system selections can include the site selections on which the listing seller wishes to place the listing. Likewise, if the listing is received from an auction manager, the auction system selections can include the list of auction systems where the lot is also being listed, if suitable. The method then proceeds to 606.

At 606, the listing information is transmitted to the auction manager, directly to other auction systems, or to other suitable systems for listings received from users of the auction system. The local listing data formats can be mapped to the auction manager format at this time, where suitable. The method then proceeds to 608.

At 608, the listing is posted on the selected auction systems by the auction manager, directly by the other auction systems, or by other suitable systems. Confirmation of the listing postings can also be provided at 608, such as by receiving a message, by accessing the other sites and verifying the listing data, or by other suitable procedures. The method then proceeds to 610.

At 610, it is determined whether a local bid has been received, such as a bid from a user of the auction system. If a local bid has not been received, the method proceeds to 616. Otherwise, the method proceeds to 612 where the bid data and listing is updated. The method then proceeds to 614 where the bid information is transmitted to the auction manager, other auction systems, or other suitable systems for posting on other sites. The method then proceeds to 616.

At 616, it is determined whether a bid has been received on another site. If no bid has been received from another site, the method proceeds to 620. Otherwise, the method proceeds to 618 where bid update data is received from the other sites. The bid update data is then reflected in the bid information on the site and the method proceeds to 620.

At 620, it is determined whether the auction has ended. If the auction has not ended, the method returns to 610. Otherwise, the method proceeds to 622 where the winning bid notification is received. The winning bid notification can be received from the auction manager or other suitable systems. The method then proceeds to 624.

At 624, it is determined whether the buyer and seller are local. If the buyer and seller are both local, the method proceeds to 626 where the buyer and seller are notified and invoiced for payment of fees using the local procedures of the auction system. Otherwise, if either the buyer or the seller is not local, then the method proceeds to 628 where the allocation of auction listing fees is performed and the sale is closed. For example, if either of the buyer or seller is not local, it will be necessary to coordinate the payment for the lot and the allocation of listing fees between the auction system and another auction system. It may first be determined whether the buyer at the other auction system has made payment, such that the other auction system must take appropriate action in the event the buyer has not paid. Likewise, any fees may be assessed and allocated at 628.

In operation, method 600 allows an auction system to coordinate with an auction manager, other auction systems, or other suitable systems to facilitate the placing of listings with such other auction systems and the processing of bids and post bid activities. Method 600 thus allows an auction system to enhance the number of listings and the number of potential bidders for such listings by coordinating with other auction systems, such as through an auction manager or other suitable systems.

Although exemplary embodiments of an auction manager system and method of operation have been described in detail herein, those skilled in the art will also recognize that various substitutions and modifications can be made to the systems and methods without departing from the scope and spirit of the appended claims.

What is claimed is:

1. An auction manager system comprising:
a master listing system receiving lot listing data and providing the lot listing data to at least one of two or more auction systems; and
a master bidding system coupled to the master listing system, the master bidding system receiving bid data associated with the lot listing data and providing the bid data to at least one of two or more auction systems.

2. The system of claim 1 wherein the master listing system further comprises a listing registration system receiving listing registration data from a user.

3. The system of claim 1 wherein the master listing system further comprises a listing distribution system placing a listing on at least one of two or more auction systems that includes the lot listing data.

4. The system of claim 1 wherein the master listing system further comprises an auction system selection system receiving user listing selections indicating which of the two or more auction systems the lot listing data is to be provided to.

5. The system of claim 1 wherein the master listing system further comprises a listing interface system receiving listing registration data from one of the two or more auction systems.

6. The system of claim 1 wherein the master bidding system further comprises a bid receiving system receiving bid data associated with the lot listing data from a user.

7. The system of claim 1 wherein the master bidding system further comprises a bid distribution system placing bid data associated with the lot listing data one at least one of the two or more auction systems.

8. The system of claim 1 wherein the master bidding system further comprises a bidding interface system receiving bid data associated with the lot listing data from one of the two or more auction systems.

9. A system for coordinating auction systems comprising:
two or more auction systems;
an auction manager coupled to the two or more auction systems; and
wherein the auction manager coordinates an auction lot listing and associated bid data between the two or more auction systems.

10. The system of claim 9 wherein one or more of the auction systems further comprises a listing registration system receiving the auction lot listing and providing the auction lot listing to auction manager.

11. The system of claim 9 wherein one or more of the auction systems further comprises a master bidding interface system receiving the bid data and providing the bid data to the auction manager.

12. The system of claim 9 wherein one or more of the auction systems further comprises a master listing interface system receiving the lot listing data and providing the lot listing data to the auction manager.

13. The system of claim 9 wherein one or more of the auction systems further comprises an auction system selection system receiving other auction system selection data from a user and providing the other auction system selection data to the auction manager.

14. A method for coordinating two or more auction systems comprising:
receiving an auction lot listing;
placing the auction lot listing on each of two or more auction systems;
receiving a bid on the auction lot listing; and
updating the auction lot listing with the bid on each of the two or more auction systems.

15. The method of claim 14 wherein receiving the auction lot listing further comprises receiving the auction lot listing from a user.

16. The method of claim 14 wherein receiving the auction lot listing further comprises receiving the auction lot listing from one of the two or more auction systems.

17. The method of claim 14 wherein placing the auction lot listing on each of two or more auction systems further comprises:
placing the auction lot listing on a first auction system; and
transmitting the auction lot listing to each of the other two or more auction systems.

18. The method of claim 14 wherein receiving the bid further comprises receiving the bid from a user.

19. The method of claim 14 wherein receiving the bid further comprises receiving the bid from one of the two or more auction systems.

20. The method of claim 14 wherein updating the auction lot listing with the bid on each of two or more auction systems further comprises:
receiving the bid at a first auction system; and
transmitting the bid to each of the other two or more auction systems.
